(19) United States
(12) Patent Application Publication
(10) Pub. No.: US 2016/0032807 A1
(43) Pub. Date: Feb. 4, 2016

(54) ELECTRICALLY HEATED CATALYST DEVICE

(71) Applicant: TOYOTA JIDOSHA KABUSHIKI KAISHA, Toyota-shi (JP)

(72) Inventors: Natsuki SUGIYAMA, Nissin-shi (JP); Hideji NAITO, Tajimi-shi (JP)

(73) Assignee: TOYOTA JIDOSHA KABUSHIKI KAISHA, Toyota-shi (JP)

(21) Appl. No.: 14/810,860

(22) Filed: Jul. 28, 2015

(30) Foreign Application Priority Data
Jul. 29, 2014 (JP) 2014-153971

(51) Int. Cl. F01N 3/20; B01D 53/94

(52) U.S. Cl. CPC F01N 3/2013; B01D 53/9495; B01D 53/9454

(57) ABSTRACT

An electrically heated catalyst device is equipped with a carrier that supports a catalyst, a pair of electric diffusion layers that are formed opposite each other on an outer peripheral face of the carrier, wiring members that are fixed to the electric diffusion layers respectively, an outer cylinder that covers an outer peripheral face of the carrier and that has, in a lateral face thereof, an opening portion through which the wiring member is pulled out to the outside, and a wiring accommodation chamber that is provided protrusively from the outer cylinder to accommodate the wiring member pulled out from the outer cylinder. The carrier is electrically heated via the wiring member. The wiring accommodation chamber is equipped with a heat radiation suppression portion for suppressing the radiation of heat from the wiring member.

### INCORPORATION BY REFERENCE

The disclosure of Japanese Patent Application No. 2014-153971 filed on Jul. 29, 2014 including the specification, drawings and abstract is incorporated herein by reference in its entirety.

### BACKGROUND OF THE INVENTION

1. Field of the Invention

The invention relates to an electrically heated catalyst device.

2. Description of Related Art

In recent years, an electrically heated catalyst (EHC) device has been drawing attention as an exhaust gas control apparatus that purifies the exhaust gas discharged from an engine of an automobile or the like. Even under a condition where the temperature of exhaust gas is low and a catalyst is unlikely to be activated, for example, immediately after the start of the engine or the like, the EHC can enhance the efficiency in purifying exhaust gas by forcibly activating the catalyst through electric heating.

With an EHC disclosed in Japanese Patent Application Publication No. 2013-136997 (JP 2013-136997 A), a surface electrode that is extended in the axial direction of a columnar carrier with a honeycomb structure is formed on an outer peripheral face of the carrier, which supports a catalyst such as platinum, palladium or the like. Then, a comb tooth-like wiring is connected to the surface electrode, and a current is supplied thereto. This current spreads in the axial direction of the carrier in the surface electrode, so the entire carrier is electrically heated. Thus, the catalyst supported by the carrier is activated, and unburned HC (hydrocarbons), CO (carbon monoxide), and NOx (nitrogen oxides) and the like in the exhaust gas flowing through the carrier are purified through a catalytic reaction.

### SUMMARY OF THE INVENTION

The inventors have found the following problem regarding the electrically heated catalyst device. In the aforementioned electrically heated catalyst device, a crack is created in the carrier through the repetition of a rise in temperature and a fall in temperature (a heat cycle), an electric current becomes unlikely to flow through part of the wiring, and an electric current concentrates on the other part of the wiring. As a result, there arises a problem of fusing.

The inventors have searched for the cause of the creation of a crack in this carrier. FIG. 7 is a graph showing how the temperatures of a carrier and an electric diffusion layer in a conventional electrically heated catalyst device change. The axis of abscissa represents time, and the axis of ordinate represents temperature. As shown in FIG. 7, when the temperature falls (when the carrier is not energized), the difference between the temperature of the carrier and the temperature of the electric diffusion layer formed directly on the carrier increases, and the thermal stress generated therebetween increases. This is inferred to result from the fact that the temperature of the electric diffusion layer is urged to fall through the radiation of heat from the wiring. Incidentally, with a view to spreading the electricity supplied from the wiring in the axial direction and the circumferential direction of the carrier, the electric diffusion layer is provided between the carrier and the surface electrode. This electric diffusion layer is omitted in Japanese Patent Application Publication No. 2013-136997 (JP 2013-136997 A).

The invention provides an electrically heated catalyst device that restrains a crack from being created in a carrier through a heat cycle.

An aspect of the invention relates to an electrically heated catalyst device comprising: a carrier that supports a catalyst; a pair of electric diffusion layers that are formed opposite each other on an outer peripheral face of the carrier; wiring members that are fixed to the electric diffusion layers respectively, and via which the carrier is electrically heated; an outer cylinder that covers the outer peripheral face of the carrier, and that has, in a lateral face thereof, an opening portion through which the wiring member is pulled out to an outside of the outer cylinder; and a wiring accommodation chamber that is provided protrusively from the outer cylinder to accommodate the wiring member pulled out from the outer cylinder, and that is equipped with a heat radiation suppression portion for suppressing radiation of heat from the wiring member.

This electrically heated catalyst device is equipped with the heat radiation suppression portion which suppresses the radiation of heat from the wiring member. Therefore, when the carrier is not energized, the temperature of the electric diffusion layers can be restrained from falling. As a result, when the carrier is not energized, the difference between the temperature of the carrier and the temperature of the electric diffusion layers is small, and the thermal stress generated therebetween is also small. Therefore, a crack can be restrained from being created in the carrier through a heat cycle.

The heat radiation suppression portion may be a heat insulating member that is provided on at least one of an outer face and an inner face of the wiring accommodation chamber. Alternatively, the heat radiation suppression portion may be a reflection member that is provided on an inner face of the wiring accommodation chamber.

Alternatively, the heat radiation suppression portion may be a heater that heats the wiring accommodation chamber. In this case, the electrically heated catalyst device may be further equipped with a controller that controls energization of the carrier and energization of the heater. The controller may start energizing the heater before turning off energization of the carrier, and may reduce an electric power for energizing the heater after turning off energization of the carrier. By controlling the energization of the heater in this manner, a crack can be more effectively restrained from being created in the carrier through a heat cycle.

The invention can provide an electrically heated catalyst device that restrains a crack from being created in a carrier through a heat cycle.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of an electrically heated catalyst device according to the first embodiment of the invention;

FIG. 2 is a perspective view obtained by removing an outer cylinder 60 from FIG. 1;

FIG. 3 is a plan view of FIG. 2 as viewed from directly above surface electrodes 20;

FIG. 4 is a cross-sectional view taken along a cutting line IV-IV of FIG. 3;

FIG. 5 is a cross-sectional view of an electrically heated catalyst device according to the second embodiment of the invention;

FIG. 6 is a graph showing a timing for energizing a carrier and a timing for energizing a heater; and

FIG. 7 is a graph showing how the temperatures of a carrier and an electric diffusion layer in a conventional electrically heated catalyst device change.

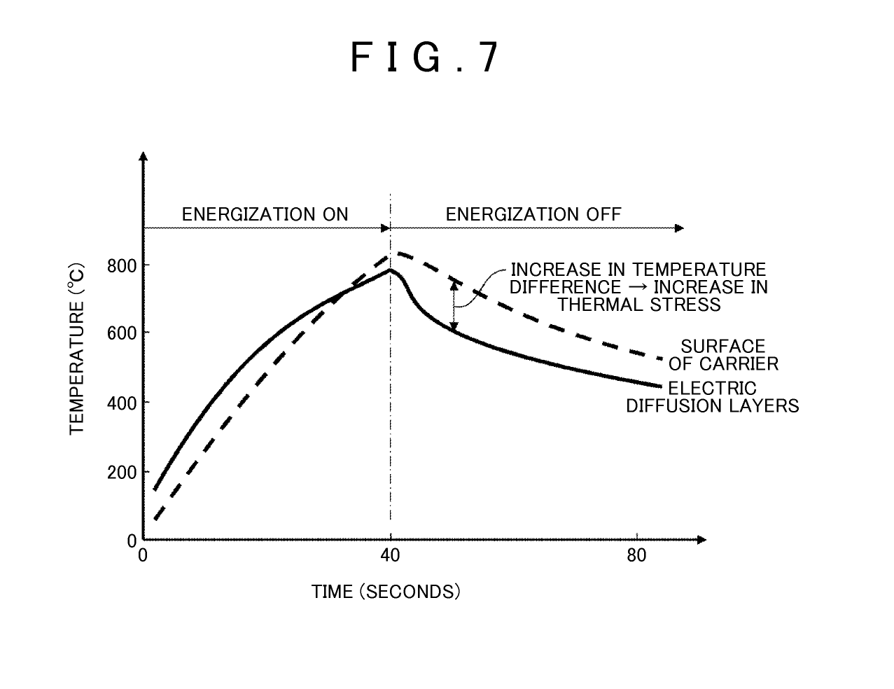

### DETAILED DESCRIPTION OF EMBODIMENTS

The concrete embodiments to which the invention is applied will be described hereinafter in detail with reference to the drawings. It should be noted, however, that the invention is not limited to the following embodiments thereof. Besides, for the sake of clear explanation, the following description and drawings are appropriately simplified.

### First Embodiment

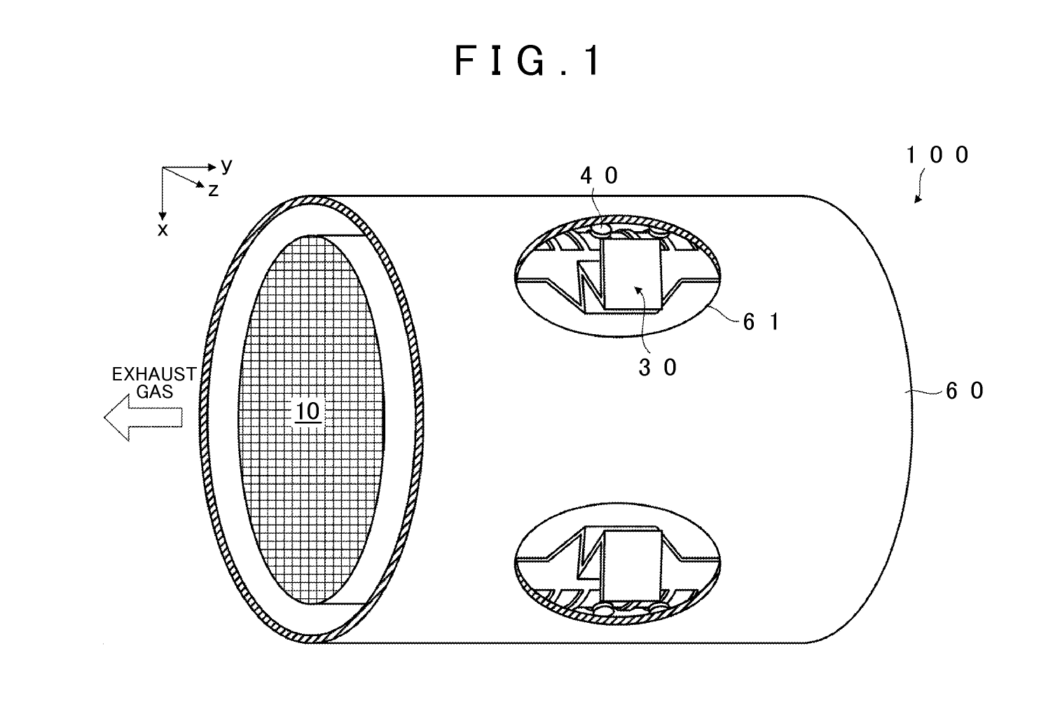

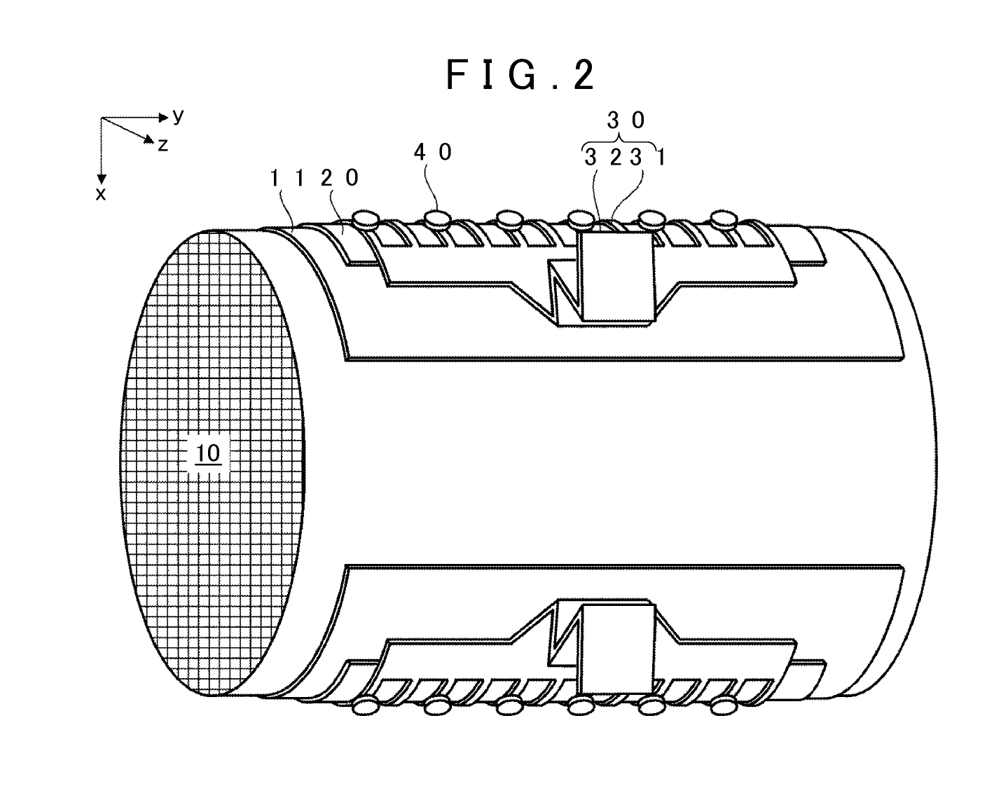

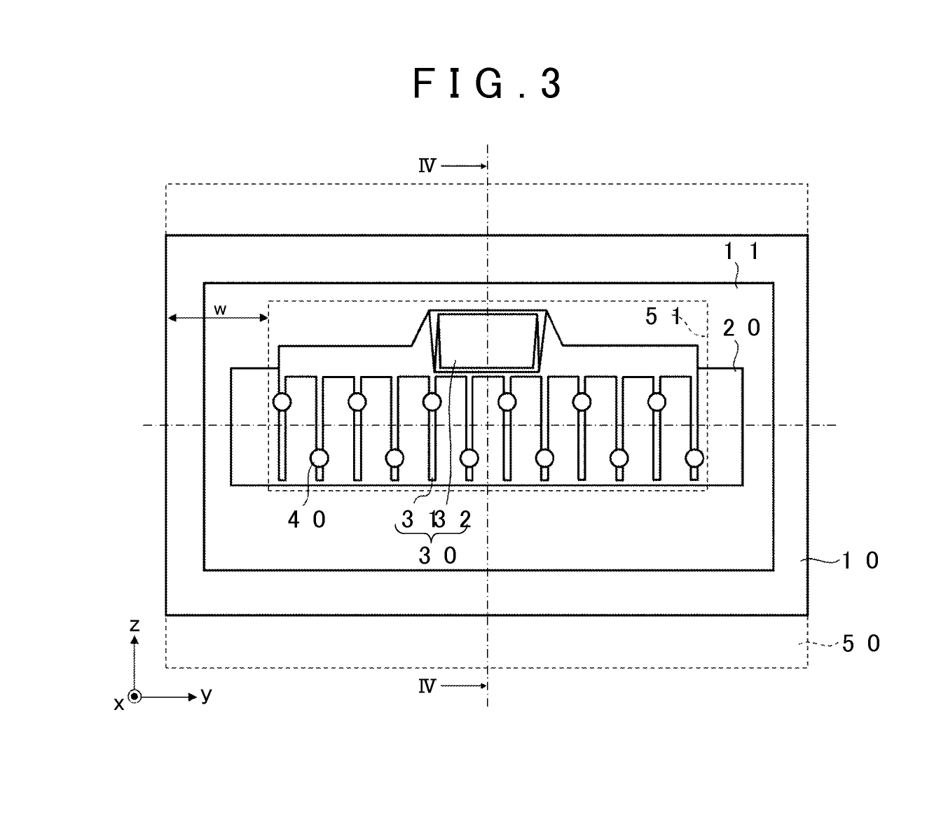

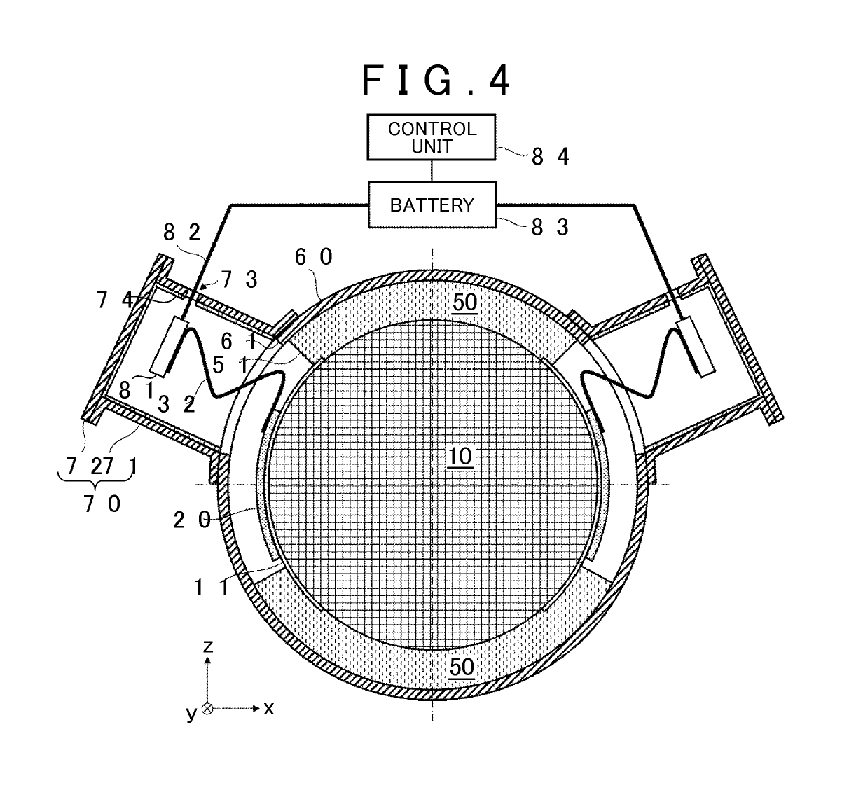

First of all, an electrically heated catalyst device according to the first embodiment of the invention will be described with reference to FIGS. 1 to 4. FIG. 1 is a perspective view of the electrically heated catalyst device according to the first embodiment of the invention. FIG. 2 is a perspective view obtained by removing the outer cylinder 60 from FIG. 1. FIG. 3 is a plan view of FIG. 2 as viewed from directly above the surface electrodes 20 (on a positive side in an x-axis direction). FIG. 4 is a cross-sectional view taken along the cutting line IV-IV of FIG. 3.

Incidentally, as a matter of course, right-handed xyz-coordinates are shown in the drawings for the sake of convenience in explaining a positional relationship among components. The xyz-coordinates are common to the respective drawings, and the axial direction of a carrier 10 is a y-axis direction. It should be noted herein that the positive side of a z-axis direction preferably coincides with an upward side of the vertical direction as shown in FIG. 4 when an electrically heated catalyst device 100 is used.

As shown in FIG. 1, the electrically heated catalyst device 100 is equipped with the carrier 10 and the outer cylinder 60. It should be noted herein that the electrically heated catalyst device 100 is equipped with electric diffusion layers 11, surface electrodes 20, wiring members 30, and fixation layers 40 on an outer peripheral face of the carrier 10 as shown in FIG. 2. Besides, as shown in FIGS. 3 and 4, the electrically heated catalyst device 100 is equipped with a mat 50 between the carrier 10 and the outer cylinder 60. Furthermore, as shown in FIG. 4, the electrically heated catalyst device 100 is equipped with wiring accommodation chambers 70 that are provided protrusively from the outer cylinder 60. That is, the electrically heated catalyst device 100 is equipped with the carrier 10, the electric diffusion layers 11, the surface electrodes 20, the wiring members 30, the fixation layers 40, the mat 50, the outer cylinder 60, and the wiring accommodation chambers 70.

Incidentally, the mat 50 and the wiring accommodation chambers 70 are omitted in FIG. 1. Besides, although FIG. 3 shows a positional relationship among the carrier 10, the electric diffusion layer 11, the wiring member 30, the fixation layer 40, and the mat 50 as to one of the surface electrodes 20, the same holds true for the other surface electrode 20. More specifically, as shown in FIGS. 2 and 4, the two surface electrodes 20 are in a positional relationship of minor symmetry with respect to a symmetry plane parallel to the yz-plane.

The electrically heated catalyst device 100 is provided on an exhaust path of, for example, an automobile or the like, and purifies the exhaust gas discharged from an engine. In the electrically heated catalyst device 100, the carrier 10 is electrically heated between the pair of the surface electrodes 20, and a catalyst supported by the carrier 10 is activated. Thus, unburned HC (hydrocarbons), CO (carbon monoxide), NOx (nitrogen oxides) and the like in the exhaust gas flowing through the carrier 10 are purified through a catalytic reaction.

The carrier 10 is a porous member that supports a catalyst such as platinum, palladium or the like. Besides, the carrier 10 itself is electrically heated, and hence is preferably made of a conductive ceramic, more specifically, SiC (silicon carbide) for example. As shown in FIG. 2, the carrier 10 has a substantially columnar outer shape, and has a honeycomb structure therein. As indicated by a blank arrow, exhaust gas flows through the inside of the carrier 10 in an axial direction of the carrier 10 (the y-axis direction).

Each of the electric diffusion layers 11 is a ceramic layer with a thickness of about 50 to 200 μm, which is formed on an outer surface of the carrier 10 to spread the electricity supplied from the wiring member 30 in the axial direction of the carrier 10 and a circumferential direction of the carrier 10. It should be noted herein that the electric diffusion layer 11 is a ceramic exhibiting lower resistance than the carrier 10, and is formed integrally with, for example, the carrier 10. More specifically, the electric diffusion layer 11 can be made to exhibit lower resistance than the carrier 10 by, for example, adding metal Si to SiC (silicon carbide) constituting the carrier 10. As a matter of course, the electric diffusion layers 11 exhibit higher resistance than the surface electrodes 20.

Besides, as shown in FIG. 2, each of the electric diffusion layers 11 is formed on a lower layer of a corresponding one of the surface electrodes 20. Besides, as shown in FIG. 3, each of the electric diffusion layers 11 has a rectangular planar shape, and is extended in the axial direction of the carrier (the y-axis direction). It should be noted herein that each of the electric diffusion layers 11 is formed in such a manner as to spread more in the axial direction and the circumferential direction of the carrier than a corresponding one of the surface electrodes 20.

As shown in FIG. 2, the surface electrodes 20 are a pair of electrodes that are formed on the electric diffusion layers 11 respectively and that are arranged opposite each other via the carrier 10. The surface electrodes 20 are in physical contact with and electrically connected to the electric diffusion layers 11 respectively. Besides, as shown in FIG. 3, each of the surface electrodes 20 has a rectangular planar shape, and is extended in the axial direction of the carrier (the y-axis direction).

Besides, each of the surface electrodes 20 is a sprayed coating with a thickness of about 50 to 200 μm, which is formed through, for example, plasma spraying. The surface electrodes 20 are energized in the same manner as the wiring members 30. Therefore, this sprayed coating needs to be a metal base. A Ni—Cr alloy (n.b., the content of Cr is 20 to 60 weight %) or an MCrAlY alloy (n.b., M is at least one of Fe, Co, and Ni), which is excellent in resistance to oxidation at high temperatures, is preferable as a metal constituting the matrix of the sprayed coating, because it must endure the conditions of use at high temperatures equal to or higher than 800° C. It should be noted herein that the aforementioned NiCr alloy or MCrAlY alloy may contain other alloying elements.

As shown in FIG. 3, each of the wiring members 30 is arranged on a corresponding one of the surface electrodes 20. As shown in FIG. 3, the wiring member 30 has comb tooth-like wirings 31 that are extended in the circumferential direction of the carrier on the surface electrode 20, and a pullout portion 32 that is connected to an external electrode 81 (FIG. 4). The wiring member 30 is, as a whole, a metal thin plate with a thickness of, for example, about 0.1 mm. The comb tooth-like wirings 31 have a width of, for example, about 1 mm. Besides, the wiring member 30 is preferably made of a heat-resistant (oxidation-resistant) alloy, for example, a stainless alloy, a Ni-group alloy, a Co-group alloy or the like, because it must endure the conditions of use at high temperatures equal to or higher than 800° C. In view of the performances such as electric conductivity, heat resistance, oxidation resistance at high temperatures, corrosion resistance in the atmosphere of exhaust gas and the like, and the costs, the stainless alloy is preferred.

As shown in FIG. 3, the plurality of the comb tooth-like wirings 31 are extended in the circumferential direction of the carrier substantially in an entire formation region of the surface electrode 20, and are provided in parallel with one another along the axial direction of the carrier (the y-axis direction) substantially at equal intervals. Furthermore, all the comb tooth-like wirings 31 are connected to the pullout portion 32 on the positive side of the formation region of the surface electrode 20 in the z-axis direction. In an example of FIG. 3, the 12 comb tooth-like wirings 31 are provided on the surface electrode 20. The comb tooth-like wirings 31 are all fixed to and electrically connected to the surface electrodes 20 by the fixation layers 40 respectively. Incidentally, as a matter of course, the number of comb tooth-like wirings 31 should not be limited to 12, but is appropriately determined.

The pullout portion 32 is not fixed to the surface electrode 20, and is pulled out to the outside of the outer cylinder 60. It should be noted herein that the pullout portion 32 has a plurality of bent portions, and is formed in an expandable/contractable manner. That is, the pullout portion 32 is formed in an accordion-like shape. In the example of the drawings, as shown in, for example, FIG. 4, the pullout portion 32 has three bent portions (two mountain folds and one valley fold as viewed from the positive side in the z-axis direction), and is formed with an M-shaped cross-section. The pullout portion 32 may have two bent portions (one mountain fold and one valley fold), and may be formed with an N-shaped cross-section. Furthermore, the pullout portion 32 may have four or more bent portions.

The accordion-like pullout portion 32 is in a folded state at the manufacturing stage. Therefore, the pullout portion 32 of the wiring members 30 does not interfere with the outer cylinder 60, and the carrier 10 that is equipped with the wiring members 30 can be press-fitted into the outer cylinder 60. Then, after the carrier 10 is press-fitted into the outer cylinder 60, the pullout portion 32 can be easily pulled out to the outside of the outer cylinder 60. It should be noted herein that the pullout portion 32 can be easily folded in an accordion-like shape by using an annealed material (with an extension percentage equal to or higher than 15%), which is obtained by annealing a cold-rolled thin plate, as the wiring members 30.

Furthermore, as shown in FIG. 4, the wiring members 30 (the pullout portion 32) are electrically connected to a battery 83 via the external electrode 81 and an external wiring 82. Due to this configuration, the carrier 10 is supplied with an electric current to be electrically heated. It should be noted herein that the battery 83 has a switch mechanism, and that a control unit 84 controls the on/off state of energization of the carrier 10. Incidentally, although one of the pair of the surface electrodes 20 is a positive electrode and the other is a negative electrode, it does not matter which one of the surface electrodes 20 is a positive electrode or a negative electrode. That is, the direction of the electric current flowing through the carrier 10 is not limited.

Each of the fixation layers 40 is a button-shaped sprayed coating with a thickness of about 300 to 500 μm, which is formed on a corresponding one of the comb tooth-like wirings 31. The fixation layers 40 can be formed by arranging the wiring members 30 on each of the surface electrodes 20, arranging a masking jig thereon, and carrying plasma spraying. The composition and the like of the sprayed coating may be set identical to those of the aforementioned surface electrodes 20.

As described above, owing to the fixation layers 40, the comb tooth-like wirings 31 are fixed to and electrically connected to each of the surface electrodes 20. In the example of FIG. 3, each of the comb tooth-like wirings 31 is fixed to the surface electrode 20 by only one of the fixation layers 40. This configuration makes it possible to lessen a thermal strain (a thermal stress) based on a difference between the linear expansion coefficient of the wiring members 30 made of a metal and the linear expansion coefficient of the carrier 10 made of a ceramic. That is, the aforementioned thermal strain (the thermal stress) is lessened by shaping each of the fixation layers 40 as compactly as possible and scattering them. Incidentally, each of the comb tooth-like wirings 31 may be fixed by two or more of the fixation layers 40. In this case, the number of fixation layers 40 and the interval among them can be appropriately determined.

The mat (a retention member) 50 is a flexible heat insulating member. As indicated by a broken line in FIG. 3, the mat 50 is wound around the entire outer peripheral face of the carrier 10. As shown in FIG. 4, the space between the carrier 10 and the outer cylinder 60 is filled with the mat 50. Owing to the mat 50, the carrier 10 is fixed to and retained by the outer cylinder 60, and is sealed such that exhaust gas does not leak to the outside of the outer cylinder 60.

As shown in FIGS. 3 and 4, the mat 50 is provided with two opening portions 51 for guiding the pullout portion 32 of the wiring members 30 to the outside of the outer cylinder 60. As shown in FIG. 3, each of the opening portions 51 is formed rectangularly at a central portion in the axial direction of the carrier 10, in such a manner as to correspond to the formation position of the wiring members 30. Besides, in a cross-sectional view shown in FIG. 4, the two opening portions 51 are arranged mirror-symmetrically to each other with respect to the symmetry plane parallel to the yz-plane. In order to ensure sealability, it is preferable that the opening portions 51 shown in FIG. 3 have a frame width w equal to or larger than 30 mm in the y-axis direction. Incidentally, although the opening portions 51 are rectangular in the example of the drawings, the shape of the opening portions 51 should not be limited in particular. For example, the opening portions 51 may assume a circular shape, an elliptical shape or the like.

The outer cylinder 60 is a housing for accommodating the carrier 10, and is a pipe having a diameter much larger than that of the columnar carrier 10. As shown in FIG. 1, the outer cylinder 60 substantially entirely covers the carrier 10 via the mat 50. It should be noted herein that the outer cylinder 60 be made of a metal, for example, a stainless alloy or the like.

As shown in FIGS. 1 and 4, opening portions 61 for guiding the pullout portion 32 of the wiring members 30 to the outside of the outer cylinder 60 are provided through a lateral face of the outer cylinder 60. Therefore, as shown in FIG. 1, the two opening portions 61 are provided at the central portion in the axial direction of the outer cylinder 60, in such a manner as to correspond to the formation position of the pullout portions 32. Besides, in the cross-sectional view shown in FIG. 4, the two opening portions 61 are arranged mirror-symmetrically to each other with respect to the plane parallel to the yz-plane, slightly above the central portion (on the positive side in the z-axis direction). Incidentally, although the opening portions 61 assume a circular shape in the example of the drawings, the shape of the opening portions 61 should not be limited in particular. For example, the opening portions 61 may assume an elliptical shape, a rectangular shape or the like.

The wiring accommodation chambers 70 are provided protrusively from the outer cylinder 60 to accommodate the pullout portions 32 of the wiring members 30 that have been pulled out from the outer cylinder 60. Therefore, as shown in FIG. 4, two opening portions 61 are provided in such a manner as to correspond to the formation positions of the pullout portions 32 respectively. Each of the wiring accommodation chambers 70 is constituted of a cylindrical torso portion 71 and a lid portion 72. It is preferable that both the torso portion 71 and the lid portion 72 be made of a metal, for example, a stainless alloy or the like.

A flange is provided at a root portion of the torso portion 71, and is fixed to the outer cylinder 60 through screwing, welding or the like. On the other hand, a flange is provided at a tip portion of the torso portion 71 as well, and the lid portion 72 is fixed thereto through screwing, welding or the like. The torso portion 71 is provided with a through-hole 73 for pulling out the external wiring 82.

It should be noted herein that heat radiation suppression means 74 for suppressing the radiation of heat from the pullout portion 32 of the wiring members 30 is provided on an inner face of the wiring accommodation chamber 70, namely, on inner faces of the torso portion 71 and the lid portion 72. The heat radiation suppression means 74 is, for example, heat insulation means for insulating the heat radiated from the pullout portion 32, or reflection means for reflecting the heat radiated from the pullout portion 32.

A coating layer or a heat insulating layer, which is made of a ceramic exhibiting heat insulating properties, for example, zirconia, alumina or the like, can be exemplified as the heat insulating means. From the standpoint of heat insulating properties, it is preferable that the coating layer be porous. The coating layer can be formed through thermal spraying, sputtering or the like. Incidentally, in the case where the heat radiation suppression means 74 is heat insulation means, the heat radiation suppression means 74 may be provided on an outer face of the wiring accommodation chamber 70 or on both the inner face and the outer face of the wiring accommodation chamber 70.

A coating layer or a metal reflection film, which is made of a metal with high heat reflectivity (e.g., Au, Al, Ni or the like), can be exemplified as the reflection means. The coating layer can be formed through plating, sputtering or the like. Besides, the inner face of the wiring accommodation chamber 70 may be minor-finished to realize the reflection means.

The electrically heated catalyst device 100 according to the first embodiment of the invention is provided with the heat radiation suppression means 74 for suppressing the radiation of heat from the pullout portions 32 of the wiring members 30, on the inner faces of the wiring accommodation chamber 70. Therefore, when the carrier 10 is not energized, the temperature of the electric diffusion layers 11 can be restrained from falling due to the radiation of heat from the wiring members 30. As a result, when the carrier 10 is not energized, the difference between the temperature of the outer surface of the carrier 10 and the temperature of the electric diffusion layers 11 is smaller than before, so the thermal stress generated therebetween can be reduced. Accordingly, the electrically heated catalyst device according to the present embodiment of the invention makes it possible to restrain a crack from being created in the carrier through a heat cycle.

Next, a method of manufacturing the electrically heated catalyst device 100 according to the first embodiment of the invention will be described with reference to FIGS. 2 and 4. First of all, as shown in FIG. 2, the surface electrodes 20 are formed respectively on the surfaces of the electric diffusion layers 11 formed integrally with the carrier 10, for example, through plasma spraying. Subsequently, the wiring members 30 with the pullout portions 32 folded in an accordion-like shape are arranged on the surface electrodes 20 respectively, and the fixation layers 40 are formed on the wiring members 30 respectively through plasma spraying with the aid of a masking jig. Thus, the wiring members 30 are fixed on the surface electrodes 20 respectively.

Subsequently, as shown in FIG. 4, the mat 50 having the opening portions 51 corresponding to the formation regions of the wiring members 30 respectively is wound around the outer peripheral face of the carrier 10 having the surface electrodes 20, the wiring members 30, and the fixation layers 40 formed thereon. It should be noted herein that the pullout portions 32 remain folded in an accordion-like shape.

Subsequently, the carrier 10 around which the mat 50 is wound is press-fitted into the outer cylinder 60. It should be noted herein that the torso portions 71 that are provided with the heat radiation suppression means 74 on the inner faces thereof are fixed in advance to the outer cylinder 60. By thereafter extending the pullout portions 32 folded in an accordion-like shape, the pullout portions 32 are pulled out to the outside of the outer cylinder 60 via the opening portions 61 respectively. Finally, after the pullout portions 32 are fixed to the external electrodes 81 respectively through screwing, welding or the like, the lid portions 72 provided with the heat radiation suppression means 74 on the inner faces thereof are fixed to the torso portions 71 respectively. Through the foregoing processes, the electrically heated catalyst device 100 according to the first embodiment of the invention can be obtained as shown in FIG. 4.

### Second Embodiment

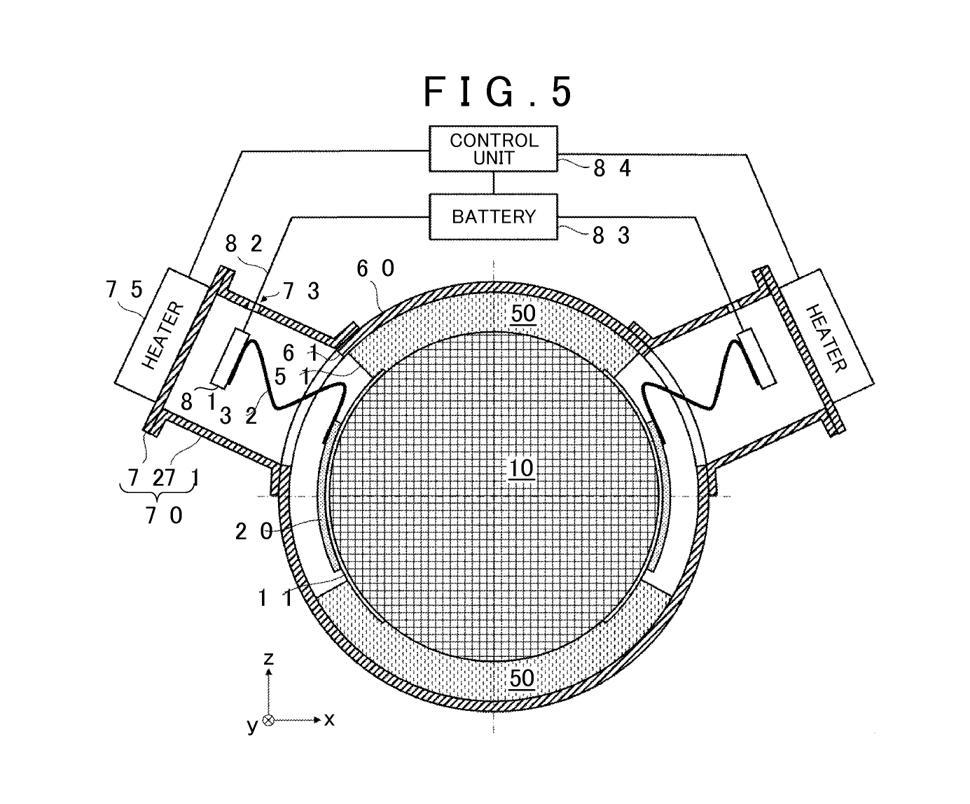

Next, an electrically heated catalyst device according to the second embodiment of the invention will be described with reference to FIG. 5. FIG. 5 is a cross-sectional view of the electrically heated catalyst device according to the second embodiment of the invention. As shown in FIG. 5, with the electrically heated catalyst device according to the second embodiment of the invention, heaters 75 for heating the wiring accommodation chambers 70 are provided on outer faces of the wiring accommodation chambers 70 respectively, instead of the heat radiation suppression means 74. The heaters 75 are, for example, small-size ceramic heaters or the like. Incidentally, although the heaters 75 are stuck on outer faces of the lid portions 72 respectively in an example of FIG. 5, the heaters 75 may be stuck on outer faces of the torso portions 71 respectively. Besides, the heaters 75 may be provided apart from the wiring accommodation chambers 70 respectively. Furthermore, the heaters 75 may be provided inside the wiring accommodation chambers 70 respectively. The second embodiment of the invention is identical in other configurational details to the first embodiment of the invention, and hence will not be described below.

The electrically heated catalyst device according to the second embodiment of the invention is provided with the heaters 75 for heating the wiring accommodation chambers 70 respectively. Therefore, when the carrier 10 is not energized, the temperature of the electric diffusion layers 11 can be restrained from falling due to the radiation of heat from the wiring members 30 respectively, by heating the wiring accommodation chambers 70 through the use of the heaters 75 respectively. As a result, when the carrier 10 is not energized, the difference between the temperature of the outer surface of the carrier 10 and the temperature of the electric diffusion layers 11 is smaller than before, and the thermal stress generated therebetween can be reduced. Accordingly, the electrically heated catalyst device according to the present embodiment of the invention makes it possible to restrain a crack from being created in the carrier through a heat cycle.

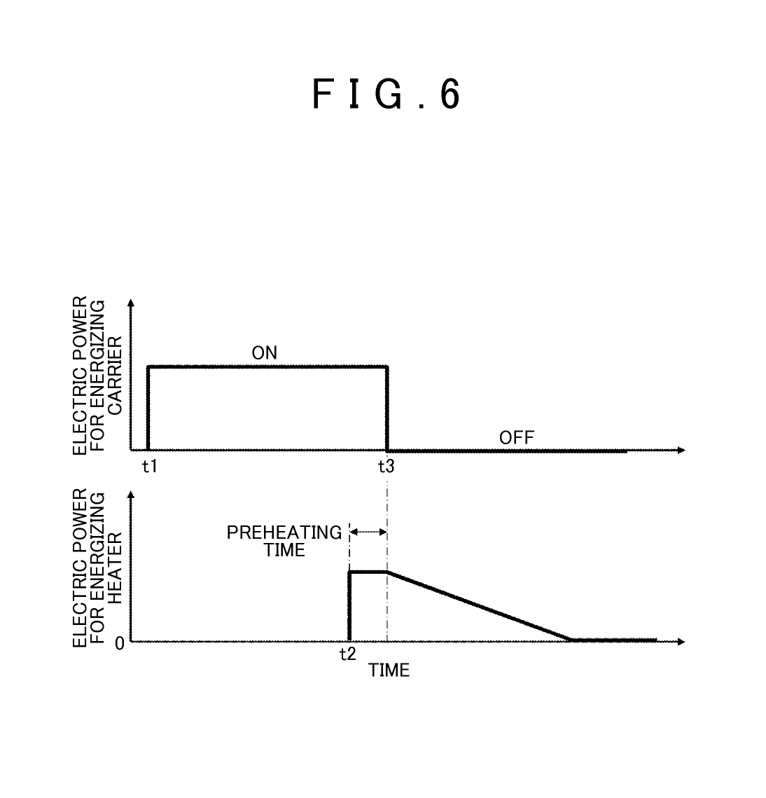

As shown in FIG. 5, with the electrically heated catalyst device according to the second embodiment of the invention, the control unit 84 controls the energization of the heaters 75 as well as the energization of the carrier 10. It should be noted herein that FIG. 6 includes graphs showing a timing for energizing the carrier and a timing for energizing the heaters. The upper graph shows the timing for energizing the carrier 10, and the lower graph shows the timing for energizing the heaters 75. The axis of abscissa represents time, and the axis of ordinate represents the amount of electric power for energization.

As indicated by the upper graph of FIG. 6, the energization of the carrier 10 is turned on at a time t1, and turned off at a time t3. As indicated by the lower graph of FIG. 6, the heaters 75 begin to be energized at a time t2 prior to the time t3 when the energization of the carrier 10 is turned off. Then, the amount of electric power for energizing the heaters 75 is gradually reduced after the time t3 when the energization of the carrier 10 is turned off.

This control makes it possible to lower the temperature of the wiring members 30 as well as the temperature of the carrier 10. Therefore, when the carrier 10 is not energized, the difference between the temperature of the outer surface of the carrier 10 and the temperature of the electric diffusion layers 11 is small, and the thermal stress generated therebetween can also be reduced. As described hitherto, the electrically heated catalyst device according to the present embodiment of the invention makes it possible to control the energization of the heaters 75, and hence can more effectively restrain a crack from being created in the carrier through a heat cycle.

Incidentally, the invention is not limited to the aforementioned embodiments thereof, but can undergo appropriate modifications without departing from the gist thereof.

What is claimed is:

1. An electrically heated catalyst device comprising:
a carrier that supports a catalyst;
a pair of electric diffusion layers that are formed opposite each other on an outer peripheral face of the carrier;
wiring members that are fixed to the electric diffusion layers respectively, and via which the carrier is electrically heated;
an outer cylinder that covers the outer peripheral face of the carrier, and that has, in a lateral face thereof, an opening portion through which the wiring member is pulled out to an outside of the outer cylinder; and
a wiring accommodation chamber that is provided protrusively from the outer cylinder to accommodate the wiring member pulled out from the outer cylinder, and that is equipped with a heat radiation suppression portion for suppressing radiation of heat from the wiring member.

2. The electrically heated catalyst device according to claim 1, wherein
the heat radiation suppression portion is a heat insulating member that is provided on at least one of an outer face and an inner face of the wiring accommodation chamber.

3. The electrically heated catalyst device according to claim 1, wherein
the heat radiation suppression portion is a reflection member that is provided on an inner face of the wiring accommodation chamber.

4. The electrically heated catalyst device according to claim 1, wherein
the heat radiation suppression portion is a heater that heats the wiring accommodation chamber.

5. The electrically heated catalyst device according to claim 4, further comprising:
a controller that is configured to control energization of the carrier and energization of the heater, wherein
the controller starts energizing the heater before turning off energization of the carrier, and reduces an electric power for energizing the heater after turning off energization of the carrier.
